(19) United States
(12) Patent Application Publication
(10) Pub. No.: US 2014/0205811 A1
(43) Pub. Date: Jul. 24, 2014

(54) MICRO-CHANNEL STRUCTURE FOR MICRO-WIRES

(71) Applicants: David Paul Trauernicht, Rochester, NY (US); John Andrew Lebens, Rush, NY (US); Yongcai Wang, Rochester, NY (US)

(72) Inventors: David Paul Trauernicht, Rochester, NY (US); John Andrew Lebens, Rush, NY (US); Yongcai Wang, Rochester, NY (US)

(21) Appl. No.: 13/746,352

(22) Filed: Jan. 22, 2013

(51) Int. Cl. G06F 3/044

(52) U.S. Cl. CPC G06F 3/044
USPC 428/172

(57) ABSTRACT

The purpose of this invention is to retain an abhor nut to a power tool while the nut is not in use. More specifically it is intended to keep the abhor nut of an angle grinder attached to the grinder. Grinding abrasives for an angle grinder can be purchased with or without a center hub. The abrasives that do not have a center hub make use of the abhor nut to secure them to the grinder. When an abrasive with a center hub is used on the grinder the abhor nut is not needed. The nut is removed from the abhor and frequently becomes misplaced. This invention keeps the grinder and nut together while the nut is not being used. This is designed for angle grinders, but could be used for other power tools and machinery.

### CROSS-REFERENCE TO RELATED APPLICATION

This application claims the benefit of U.S. Provisional Patent Application No. 61/632,306, filed Jan. 23, 2012, which is incorporated herein by reference in its entirety.

### BACKGROUND OF THE INVENTION

1. Field Of The Invention

The present invention relates to a method of unification of a power tool and it's sometimes used parts. More specifically to securing an abhor/retaining nut to an angle grinder while the nut is not in use. This is done to prevent the loss of the abhor/retaining nut.

2. Description Of The Related Art

Angle grinders can be used with a plurality of stones, wire brushes, sanding disks and grinding and cutting wheels. This selection of attachments will herein after be collectively referred to as abrasives and will only be distinguished as abrasives with a center hub or center hole. Some abrasives are manufactured with a hole in the middle that passes through the abhor and then secured in place with a retaining/abhor nut. Other abrasives are manufactured with a center hub which is a threaded nut which receives the abhor and is incorporated as part of the abrasive wheel. Because this hub screws on to the grinder's abhor it replacing the need for a retaining/abhor nut while this form of abrasive is being used. During the use of an abrasive with a center hub the retaining/abhor nut frequently becomes misplaced. Abrasives that are held in place with an abhor/retaining nut usually also have a backing plate or flange. This is also sometimes also removed from the abhor when an abrasive with a hub is in use. These two pieces (the abhor/retaining nut and the backing plate/flange) will hereinafter be collectively referred to as the nut. The present invention can hold one or both of these pieces. Angle grinders frequently are manufactured with a threaded bore on each side of the front housing. The intended purpose of these threaded holes is to receive a handle/paddle that provides the operator with greater leverage and control of the grinder when it is in use. One hole on each side of the grinder is necessary to accommodate left and right handed users; some grinders also have third hole on the top. The preferred embodiment is threaded into one of the unused holes that is intended for the handle/paddle, thereby keeping the auxiliary parts with the grinder until they are required for use.

### SUMMARY OF THE INVENTION

The present invention is an apparatus designed to prevent the nut from becoming misplaced when its use is not required for the operation of an angle grinder. The present invention extends a material from the grinder for the nut to be placed on where it is held in place against a flange by being threaded onto the material or held in place by magnetic force. The nut that secures the abrasive with a center hole to the grinder are typically 1⅜-1¾″ inches in OD with a center boss that is typically 0.870 inch OD and extends about 1/16 inch of an inch beyond the flange surface of the nut. It is the purpose of this center boss to create a shoulder for the abrasive with a center hole to align itself upon and to transfer the rotating motion of the grinder to the abrasive. The preferred embodiment of this present invention makes use of a counter bore to receive the center boss of the nut. This enlarges the surface area that the nut attaches to the invention making it less likely for the nut to work its way lose due to vibration of the grinder during use.

In the preferred embodiment the flange is attached to a short screw that attaches to the angle grinder where a handle/paddle would ordinarily be located. The nut is then secured to the flange by a thread that is the same size as the abhor of the grinder.

In the magnetic embodiment the nut is secured to a center shaft and the flange by magnetic attraction.

In the handle embodiment the nut is secured to the flange by a thread that extends out of the end of the handle that is attached to the angle grinder to increase the leverage of the user.

Thread size M8 is the typical size threads used by manufacturers to attach the handle/paddle to the grinder, but other sizes exist. NC ⅝-11 is the typical size threads used by manufactures for the abhor of an angle grinder, but other sizes exist. The preferred embodiment makes use of these typical sizes but could be fitted with any size threads used by the manufacture.

### BRIEF DESCRIPTION OF DRAWINGS

FIG. 1 Shows a top view of the preferred embodiment.

FIG. 2 Shows the front view of the preferred embodiment.

FIG. 3 Shows the bottom view of the preferred embodiment

FIG. 4 show a full section cutting plane of the preferred embodiment.

FIG. 5 Shows a top view of an alternative (magnetic) embodiment.

FIG. 6 Shows a front view of an alternative (magnetic) embodiment.

FIG. 7 Shows the bottom view of the alternative embodiment.

FIG. 8 Shows the front view of the handle alternative embodiment

FIG. 9 is a cross sectional cut plane of FIG. 8 and shows how parts 1 and 3 are embedded into part 2.

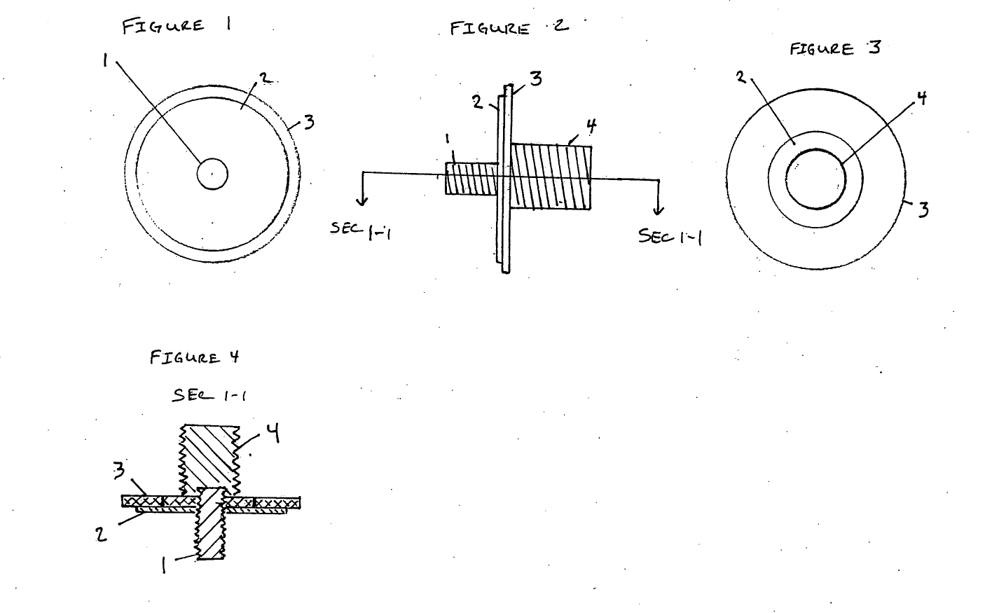

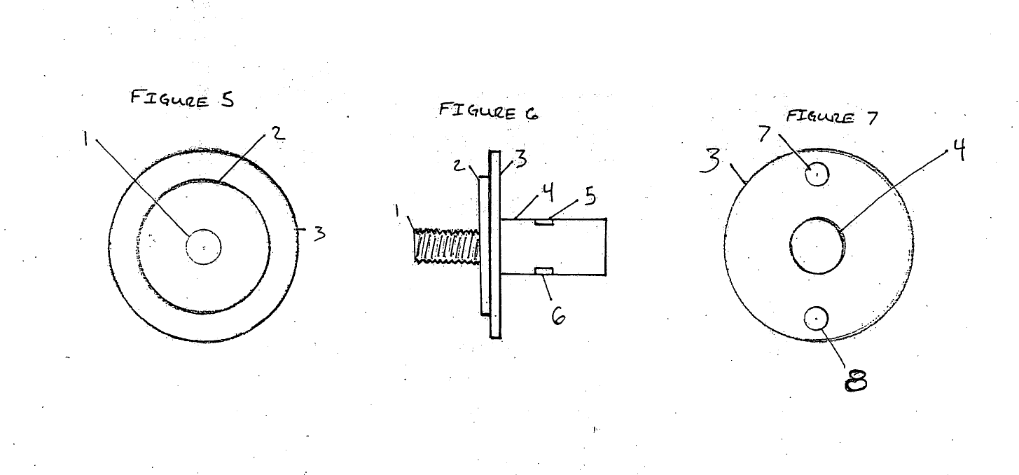

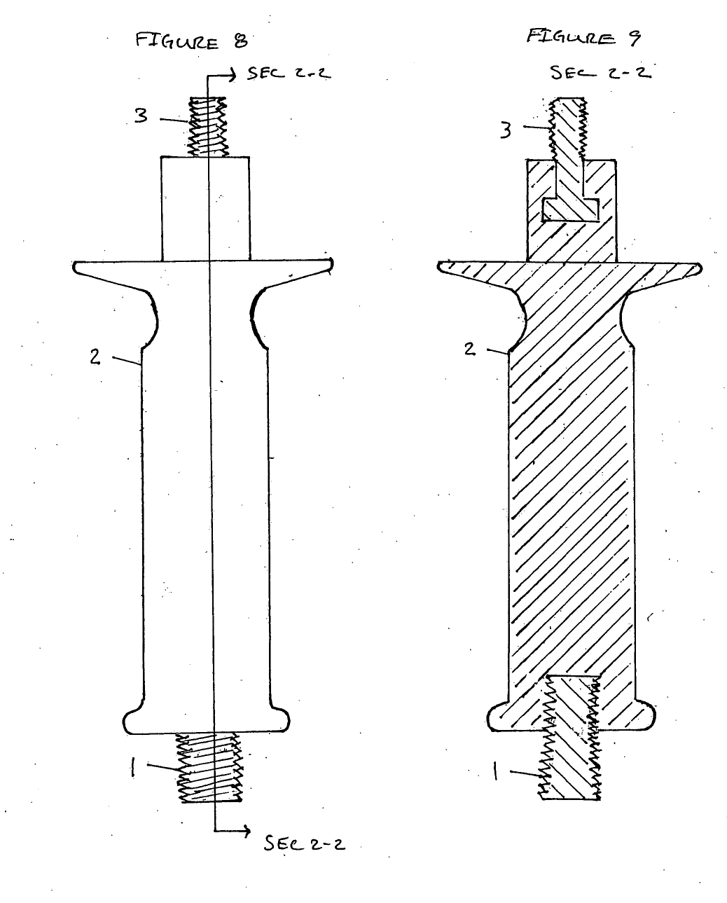

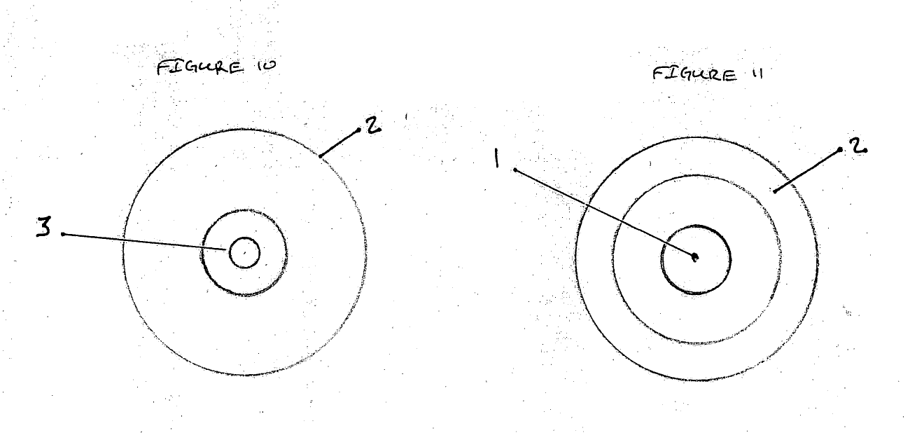

### BRIEF DESCRIPTION OF PREFERRED EMBODIMENTS

The preferred embodiment herein described is not intended to be exhaustive or to limit the invention to the precision form disclosed. It is chosen and described to best explain the invention so that others, skilled in the art to which the invention pertains, might utilize its teachings.

Referring now to the drawings and to figure: The smaller threaded end, part 1, screws into the angle grinder. The nut screws on to the larger threaded end 4 and butts up against the backing plates 3 and 4. The preferred embodiment is made of steel washers and allthread, however it could be made of any suitable material. The preferred embodiment was made of a ¾ in long piece of M8×1.25 all thread (part 1) and a one inch long piece of ⅝-11 allthread (part 4) which was counter bored ¼ of an inch on one side and threaded to receive M8×1.25. These two were then coupled together. A 1.5 OD×0.30 ID× 1/16 thick flat fender washer (part 2) was then threaded to receive the M8×1.25 shaft and screwed on until the washer bottomed out on the shoulder created between the larger and smaller pieces of allthread. A 1.75 OD×0.95 ID×⅛ thick flat washer (part 3) was then placed over the previous washer on the side of the smaller threads and centered. The difference in outside diameters between the two washers created a lap joint which was then welded with the GTAW or gas tungsten arc welding process. A small fillet weld was also made to secure the thinner washer to the allthread.

The preferred embodiment makes use of a counter bore that is created by the difference of the inside diameter dimension the two washers. This counter bore receives the boss that protrudes from the nut. When this happens the flange of the nut mates up with the flange of the preferred embodiment and increases the surface area that the two parts have in common.

The second (magnetic) embodiment of the invention is similar in size and construction to the first. However, this one holds the nut in place with 3/16 diameter rare earth magnets (Parts 5,6,7, and 8) rather than a threaded shaft. The embodiment attaches to the grinder with (Part 1) with a M8×1.25 allthread 20 mm long and has been welded into (Part 4) a Y2 inch OD 1/16″ wall tube 1 3/16 inch long with the GTAW process. A flat washer (Part 2) is also welded with the GTAW process and attached at the base of the tube where the allthread is welded a 1¼ inch OD ½″ ID flat washer is welded to the tube. On the other side of (Part 2) this flat washer is another flat washer (part 3) 1¾″ OD 15/16″ ID. These two washers are welded together concentrically with the GTAW process. The flat washers (parts 3 and 4) are both bored with a 7/32 inch diameter hole at the locations shown on the drawings and receive (parts 5,6,7 and 8). Rare earth magnets were inserted into these holes and held in place with a two part resin epoxy. For this embodiment Epoxo 88-T10 was adjoining material.

The third embodiment submitted is a molded handle/paddle that is typical of those supplied by the manufactures of angle grinders at the time of purchase. The body of this handle/paddle (part 2) has been modified with a NC ⅝-11 piece of allthread (part 1) extending ¾ of an inch from the outer edge of what would usually be the end of the handle/paddle. The handle/paddle is connected to the angle grinder by a M8×1.25×30 mm bolt (part 3) embedded into the molded body and extending 9/16 of an inch beyond. In this embodiment the nut is threaded onto the end of the handle/paddle that does not connect to the grinder. This embodiment is made of short strand fiberglass and fiberglass resin and steel but any suitable materials could be used.

1. A micro-channel structure for facilitating the distribution of a curable ink, comprising:
a substrate;
a single cured layer formed on the substrate, the single cured layer having one or more micro-channels embossed therein and an RMS surface roughness between or within micro-channels of less than or equal to 0.2 microns, wherein the micro-channels are adapted to receive curable ink;
cured ink in each micro-channel; and
wherein the thickness of the single cured layer is in a range of about two microns to ten microns greater than the micro-channel thickness and wherein the thickness of the single cured layer is in the range of about twelve microns to four microns.

2. The micro-channel structure of claim 1, wherein the surface of the single cured layer is substantially planar.

3. The micro-channel structure of claim 1, wherein the surface of the single cured layer has an RMS surface roughness of less than or equal to 0.1 microns.

4. The micro-channel structure of claim 1, wherein the surface of the single cured layer is has an RMS surface roughness of less than or equal to 0.05 microns.

5. The micro-channel structure of claim 1, wherein the cured ink is a conductive ink forming a micro-wire in each micro-channel.

6. The micro-channel structure of claim 5, wherein the cured conductive ink includes sintered electrically conductive nano-particles.

7. The method of claim 6, wherein the electrically conductive nano-particles are silver, a silver alloy, include silver, or have an electrically conductive shell.

8. The micro-channel structure of claim 1, wherein the substrate has a first side opposite and substantially parallel to a second side, the single cured layer is on the first side, and further including:
a second single cured layer formed on the substrate second side, the second single cured layer one or more second micro-channels formed therein and an RMS surface roughness between or within second micro-channels of less than or equal to 0.2 microns wherein the second micro-channels are adapted to receive curable ink;
cured ink in each second micro-channel; and
wherein the thickness of the second single cured layer is about two microns to ten microns greater than the second micro-channel thickness.

9. The micro-channel structure of claim 8, wherein the cured ink is a conductive ink forming a micro-wire in each micro-channel and in each second micro-channel.

10. The micro-channel structure of claim 8, wherein the thickness of the single cured layer is substantially equal to the thickness of the second single cured layer.

11. The micro-channel structure of claim 8, wherein the thickness of the single cured layer is different from the thickness of the second single cured layer.

12. (canceled)

13. The micro-channel structure of claim 1, wherein the width of the micro-channel is in the range of about twelve microns to two microns.

14. The micro-channel structure of claim 1, wherein the thickness of the micro-channel is in the range of about ten microns to two microns.

15. The micro-channel structure of claim 1, wherein the surface of the single cured layer has a water contact angle greater than 45 degrees.

16. The micro-channel structure of claim 1, wherein the single cured layer has multiple sub-layers.
